(19) United States
(12) Patent Application Publication
(10) Pub. No.: US 2023/0163396 A1
(43) Pub. Date: May 25, 2023

(54) CONNECTING DEVICE FOR CONNECTING AN ELECTRIC DEVICE TO ANOTHER ELECTRIC DEVICE

(71) Applicant: BETTERIES AMPS GMBH, Berlin (DE)

(72) Inventors: Joscha WINZER, Berlin (DE); Rainer HÖNIG, Berlin (DE)

(21) Appl. No.: 17/919,127

(22) PCT Filed: Apr. 9, 2021
(86) PCT No.: PCT/EP2021/059263

§ 371 Date: Oct. 14, 2022

(30) Foreign Application Priority Data
Apr. 15, 2020 (LU) LU101734

(51) Int. Cl. H01M 50/258; H01M 50/209; H01M 10/6568

(52) U.S. Cl. CPC H01M 50/258; H01M 50/209; H01M 10/6568

(57) ABSTRACT

The invention relates to a connecting device for connecting an electrical apparatus to another electrical apparatus, with a connection by means of which the electrical apparatus can be electrically and/or hydraulically connected to the other electrical apparatus, a connection body that has a plurality of alignment sections that are designed in such a way that during a connection process, the electrical apparatus is aligned with the other electrical apparatus in a plurality of spatial directions in a plurality of steps.

The invention relates to a connecting device for connecting an electrical apparatus to another electrical apparatus. In addition, the invention relates to a counter-connecting device for connecting another electrical apparatus to such a connecting device. In addition, the invention relates to an electrical apparatus with at least one such connecting device and/or such a counter-connecting device. In addition, the invention relates to a device system with such an electrical apparatus and another electrical apparatus.

A large number of connecting devices are known from the prior art, by means of which an electrical apparatus can be electrically connected to another electrical apparatus. However, the known connecting devices have the disadvantage that the two electrical apparatuses can only be connected along a predetermined connection direction in order to prevent electrical lines from being damaged during the connection process. To do this, the two electrical apparatuses must be aligned relative to one another prior to a connection process. However, alignment is sometimes not possible or is time consuming.

The object of the invention is to specify a connecting device by means of which it is possible to connect electrical apparatuses in a simple manner.

The object is achieved by a connecting device for connecting an electrical apparatus to another electrical apparatus, with a connection by means of which the electrical apparatus can be electrically and/or hydraulically connected to the other electrical apparatus, a connection body that has a plurality of alignment sections that are designed in such a way that during a connection process, the electrical apparatus is aligned with the other electrical apparatus in a plurality of spatial directions in a plurality of steps.

The connecting device according to the invention has the advantage that it is no longer necessary for the two electrical apparatuses to be precisely aligned relative to one another prior to a connection process. According to the invention, it was recognized that by providing a plurality of alignment sections, it is no longer necessary to precisely align the two electrical apparatuses with one another before connecting the electrical apparatuses. The alignment sections are designed and arranged in such a way that, during the connection process, they bring about an alignment of the electrical apparatus with respect to the other electrical apparatus in a plurality of spatial directions in a plurality of successive steps. This simplifies the connection process in that the alignment process no longer has to be carried out by the user, but instead is carried out by the connecting device itself.

Within the meaning of the invention, an electrical apparatus is a device that has electronics and/or an electrical storage device. The electronics can have a control device, which has a processor, for controlling switches and/or battery cells and/or other control devices, for example.

The alignment sections are designed in such a way that the individual steps in which the electrical apparatus is aligned with respect to the other electrical apparatus in a spatial direction are time-delayed with respect to one another. The alignment sections can be designed in such a way that the electrical apparatus is only aligned in one spatial direction in a step when an alignment process of the electrical apparatus in another spatial direction has been completed in a previous step. Alternatively, the alignment of the electrical apparatus in a spatial direction can be started in one step, even if the alignment process has not yet been completed in a previous step.

The connecting device can be designed in such a way that after the connection process, the electrical apparatus is mechanically connected to the other electrical apparatus. The mechanical connection can be a positive and/or non-positive and/or frictional connection. In addition, the mechanical connection can be designed in such a way that the electrical apparatus and the other electrical apparatus cannot be rotated relative to each other after the two devices are mechanically connected.

The connecting device can be electrically and/or mechanically and/or hydraulically connected to the electrical apparatus, in particular in a detachable manner. The connecting device can be firmly connected to the electrical apparatus. In this case, the connecting device and the electrical apparatus can only be moved together.

The connection can have one or more lines. A line can act as a data line. In addition, a line can be a power line for transmitting electric power. The electrical energy can be supplied to an electrical storage device or an electrical consumer. In addition, a line can be a fluid line. The fluid line serves to transfer fluid, in particular liquid fluid. The fluid can serve to cool the electrical apparatus or the other electrical apparatus. The connection can have one or more data lines and/or one or more lines for transmitting electrical energy and/or one or more fluid lines.

In a special embodiment, the connection body can be designed in such a way that the connection can only be electrically and/or hydraulically connected to the other electrical apparatus when the electrical apparatus and the other electrical apparatus are aligned with one another. This means that the electrical and/or hydraulic connection can only be established after a plurality of steps have been completed and the electrical apparatus is aligned in a plurality of spatial directions, in particular exactly two spatial directions, with respect to the other electrical apparatus. This offers the advantage that damage to the connection, in particular to the electrical lines, can be prevented.

The connection is prevented from being damaged by the fact that, after the electrical apparatus has been aligned with the other electrical apparatus, the connection is in a predetermined position relative to a counter-connection of a counter-connecting device, described in detail below, of the other electrical apparatus. Starting from the predetermined position, an electrical and/or hydraulic connection of the connection to the counter-connection can be implemented without damaging the lines of the connection.

The connecting device can be connected to the electrical apparatus in such a way that after the electrical apparatus and the other electrical apparatus have been aligned, the connecting device is aligned with the counter-connecting device of the other electrical apparatus.

In addition, the connection body can be designed in such a way that in a first step, the electrical apparatus is aligned in a first spatial direction to the other electrical apparatus and in a second step, the electrical apparatus is aligned in a second spatial direction to the other electrical apparatus. The second step is time-delayed in relation to the first step.

In addition, the connection body can be designed in such a way that when the connecting device is moved along a connecting direction in a first step, the electrical apparatus is aligned in a first spatial direction with respect to the other electrical apparatus, and when the connecting device is moved further along the connecting direction in a second step, the electrical apparatus is aligned in a second spatial direction with respect to the other electrical apparatus. A connecting device designed in this way offers the advantage that the user only has to move the connecting device along the connecting direction, which simplifies the connection process.

The first spatial direction and the second spatial direction can be perpendicular to one another. In addition, the first spatial direction and the second spatial direction can be transverse, in particular perpendicular, to the connection direction of the connecting device. The connection direction is understood to mean the direction along which the connecting device is moved during the connection process.

In a special embodiment, the connection body can have at least one first alignment section for aligning the electrical apparatus relative to the other electrical apparatus in the first spatial direction. In addition, the connection body can have at least one second alignment section for aligning the electrical apparatus relative to the other electrical apparatus in the second spatial direction.

The alignment sections can be designed in such a way that they guide the electrical apparatus and/or the other electrical apparatus during the connection process. In particular, the first alignment section can guide the movement of the electrical apparatus until the electrical apparatus and the other electrical apparatus are aligned with one another in the first spatial direction. The second alignment section can guide the movement of the electrical apparatus until the electrical apparatus and the second electrical apparatus are aligned with one another in the second spatial direction.

An edge side of the connection body may have the first alignment section. In this case, the first alignment section can have a bevel. The first alignment section may be located at an end of the edge side. In addition, a plurality, in particular precisely two, first alignment sections can be present. In this case, different edge sides of the connection body can each have a first alignment section.

The connection body can have a trapezoidal cross section. In this case, the bevel can be arranged on one edge side of the connection body and another bevel can be arranged on a further edge side, which is opposite the edge side. In particular, the bevels can be arranged on edge sides of the connection body that are not parallel to one another. The bevels offer the advantage that the connecting device and thus the electrical apparatus can be easily aligned in the first spatial direction with respect to the other electrical apparatus.

An edge side of the connection body may have the second alignment section. In this case, the same edge side can have the first and second alignment section. In this case, the second alignment section can at least partially overlap with the first alignment section. In particular, part of the second alignment section can be arranged in the first alignment section. The second alignment section can be formed as a longitudinal groove. The longitudinal groove may partially extend into the first alignment section.

The connection body can have a coupling-in section which is arranged at one end of the second alignment section, in particular the longitudinal groove. The coupling-in section can be a recess. In this case, the coupling-in section can be arranged on the first alignment section, in particular on the bevel. The coupling-in section can be longer in the second spatial direction than the second alignment section. This offers the advantage that a counter-alignment section of the counter-connecting device, which is described in more detail below, can be inserted more easily into the alignment section.

In a special embodiment, the connecting device can have a connecting plate for connecting to the electrical apparatus, in particular in a detachable manner. Alternatively, the connecting device can be designed in one piece with a component part of the electrical apparatus. The connection body can protrude from the connecting plate, in particular along the connecting direction. The connecting device can be mechanically connected to different electrical apparatuses in a simple manner by means of the connecting plate. The same connecting device can thus be used with different electrical apparatuses. It is therefore not necessary for a separate connecting device to be developed for each electrical apparatus.

In this case, the connecting device can have at least one rail-shaped projection which is arranged on another edge side of the connection body. By providing a predetermined number of rail-shaped projections on the other edge side, the electrical apparatus and the other electrical apparatus can be easily prevented from being electrically connected to each other at the wrong poles.

In a particular embodiment, the connection body can be hollow. The electrical connection can be arranged at least partially within a cavity of the connection body. At least one power line of the electrical connection for transmitting electrical energy and/or at least one data line of the electrical connection for transmitting data and/or at least one fluid line for transmitting fluid can be arranged within the cavity. As a result, a compactly designed connecting device is realised.

A counter-connecting device for connecting another electrical apparatus to a connecting device according to the invention is particularly advantageous. The counter-connecting device can be electrically and/or mechanically and/or hydraulically connected to the other electrical apparatus, in particular in a detachable manner. The counter-connecting device can be connected to the other electrical apparatus in such a way that after the electrical apparatus and the other electrical apparatus have been aligned, the connecting device is also aligned with the counter-connecting device.

The connection between the electrical apparatus and the other electrical apparatus can be realised by a plug-in connection. In this case, the connecting device forms part of the plug-in connection and the counter-connecting device forms another part of the plug-in connection.

The counter-connecting device can have a counter-connection, by means of which the other electrical apparatus can be electrically and/or hydraulically connected to the electrical apparatus. In particular, the counter-connection can be electrically and/or hydraulically connected to the connection of the connecting device. For this purpose, the electrical counter-connection can have the same number of lines as the electrical connection.

In addition, the counter-connecting device can have a counter-connection body which is designed in such a way that the counter-connection is only electrically and/or hydraulically connected to the electrical apparatus, in particular the connection of the connecting device, when the electrical apparatus and the other electrical apparatus are aligned with one another. In this respect, the counter-connection can only be electrically and/or hydraulically connected to the connection when the individual steps in which the connecting device and the counter-connecting device are aligned in different spatial directions relative to one another have been completed.

The counter-connection body can be designed in such a way that in a first step, the other electrical apparatus, in particular the counter-connecting device, is aligned in a first spatial direction with respect to the electrical apparatus, in particular the connecting device, and in a second step, the other electrical apparatus is aligned in a second spatial direction with respect to electrical apparatus. The second step takes place at a later time than the first step.

In addition, the counter-connection body can be designed in such a way that when the counter-connecting device is moved along a connection direction in a first step, the other electrical apparatus is aligned in the first spatial direction with respect to the electrical apparatus, and when the counter-connecting device is moved further along the connection direction in a second step, the other electrical apparatus is aligned with the electrical apparatus in the second spatial direction. A counter-connecting device designed in this way offers the advantage that the user only has to move the connecting device and/or the counter-connecting device along the respective connection direction, which simplifies the connection process.

In a particular embodiment, the counter-connection body can have a bulge. During a connection process, the connection body of the connecting device can penetrate into the bulge. The bulge can be complementary in shape to an outer contour of the connection body of the connecting device. A counter-connecting device designed in this way offers the advantage that a mechanical connection between the connecting device and the counter-connecting device can be implemented in a simple manner.

The bulge can be delimited by two wall legs of the counter-connection body. The wall legs can be designed and arranged in such a way that they delimit an insertion opening through which the connection body of the connecting device can be inserted into the bulge.

In addition, the wall legs can be designed and arranged in such a way that, during a connection process, the wall legs bring about an alignment of the other electrical apparatus with respect to the electrical apparatus in the first spatial direction. For this purpose, a wall leg comes into contact with the bevel, which, when the connecting device and/or counter-connecting device is moved along the respective connecting direction, results in the connecting device and the counter-connecting device being aligned with one another in the first spatial direction.

In a special embodiment, the counter-connecting device can have a counter-alignment section for aligning the other electrical apparatus with respect to the electrical apparatus in a second spatial direction.

The counter-alignment section can be attached to an inner side of the wall leg. The inner side of the wall leg is understood to mean the side of the wall leg that faces the bulge. In addition, the counter-alignment section can be arranged offset in relation to the insertion opening in the connection direction. This makes it possible for the alignment in the second spatial direction to begin with a time delay in relation to the alignment in the first spatial direction. In particular, the alignment of the connecting device and the counter-connecting device in a second spatial direction relative to one another can only take place after the alignment of the connecting device and the counter-connecting device has begun in the first connecting device.

The counter-alignment section can be designed to complement the shape of the second alignment section of the connecting device. As a result, the connecting device and the counter-connecting device can be easily aligned with one another in the second spatial direction.

The counter-connecting device can have at least one rail-shaped recess which is arranged on an inner side of the counter-connection body. The rail-shaped recess can be arranged in a part of the counter-connection body that is released from the bulge. The rail-shaped recess can be designed to complement the rail-shaped projection of the connecting device. After the connection process, the rail-shaped projection of the connecting device is arranged in the rail-shaped recess of the counter-connecting device.

The electrical counter-connection may partially extend into the bulge. The electrical counter-connection can have at least one power line for transmitting electrical power and/or at least one data line for transmitting data and/or at least one fluid line for transmitting fluid, in particular for cooling the electrical apparatus and/or the other electrical apparatus.

An electrical apparatus with at least one connecting device according to the invention and/or at least one counter-connecting device according to the invention is particularly advantageous. The electrical apparatus can be connected to another electrical apparatus by means of the connecting device and/or the counter-connecting device. In this case, the connecting device and/or the counter-connecting device can be electrically and/or mechanically and/or hydraulically connected to the electrical apparatus.

The other electrical apparatus can be electrically and/or mechanically and/or hydraulically connected to a connecting device and/or at least one counter-connecting device, analogously to the electrical apparatus. The other electrical apparatus can be configured identically to the electrical apparatus. The electrical apparatus and the other electrical apparatus can therefore have the same electronics and/or the same electrical storage device. Alternatively, the other electrical apparatus can have different electronics than the electrical apparatus.

The electrical apparatus can have a housing and a control device arranged in a cavity of the housing for controlling or regulating the other electrical apparatus that can be electrically and mechanically connected to the electrical apparatus. The control device can also control or regulate the electronics present in the electrical apparatus. In addition, the electrical apparatus can have an electrical connection to an electrical consumer or an electrical energy source. Battery cells, which are arranged in a battery module described in more detail below, can be charged via the electrical energy source.

The connecting device and/or the counter-connecting device can be arranged on a housing side of the electrical apparatus. In this case, the connecting device and the counter-connecting device can be arranged on opposite sides of the housing in relation to the connection direction.

In a particular embodiment, the electrical apparatus can be a battery module that has a large number of battery cells and a module control device for controlling or regulating the battery cells. A battery module is understood to be a unit that is able to store or deliver electrical energy. The electrical energy can be delivered, for example, by the electrical apparatus described above, which has a connection for connecting electrical consumers and which can be electrically and mechanically connected to the battery module. In this case, the control device of the electrical apparatus can control or regulate the battery module. A module is understood to be a functionally closed unit. The individual module components can be moved together and/or the module is connected as a whole to an electrical apparatus, for example.

The connecting device can be arranged on one side of the connection housing and the counter-connecting device on another side of the connection housing, wherein the connecting device and the counter-connecting device are opposite one another, in particular in relation to the connection direction.

The battery module can have a housing that encloses the battery cells, in particular completely, wherein the connecting device and/or the counter-connecting device can be arranged on a front side of the housing.

In an embodiment in which the electrical apparatus, in particular the battery module, has a plurality of connecting devices, a first connecting device can be arranged on a first end section of the housing and a second connecting device can be arranged on a second end section of the housing. In an embodiment in which the battery module has a plurality of counter-connecting devices, a first counter-connecting device can be arranged on a first end section of the housing and a second counter-connecting device can be arranged on a second end section of the housing. The two end sections of the housing can face each other with respect to a longitudinal direction of the housing.

In a special embodiment, the battery module can have at least one support device for the other electrical apparatus. The support device can be detachably connected to the housing. The support device has the advantage that it supports the other electrical apparatus when the electrical apparatus is electrically and mechanically connected to the other electrical apparatus. The other electrical apparatus thus rests on the housing of the electrical apparatus by means of the support device. This offers the advantage that component tolerances and/or thermal deformations of the electrical apparatus, in particular the housing of the electrical apparatus, and the other electrical apparatus, in particular another housing of the other electrical apparatus, have no influence on the connection process.

The support device can consist of a material that has a smaller or the same thermal expansion coefficient as the housing and/or the connecting device and/or the counter-connecting device. This reduces the influence of thermal deformation of the housing on the connection process.

The support device can have a support element and a plate protruding from the support element. The plate can form a wall of the connecting device, in particular of the connection body. In addition, the plate can extend in a direction away from the housing. A predetermined number of rail-shaped projections can be arranged on the side of the plate facing away from the connecting device.

The electrical apparatus can have at least one supporting element. The supporting element can be detachably connected to the housing. The supporting element can consist of a material that has a lower coefficient of thermal expansion than the housing and/or the connecting device and/or the counter-connecting device. This reduces the influence of thermal deformation of the housing on the connection process. The electrical apparatus rests on another support device of the other electrical apparatus by means of the supporting element.

The electrical apparatus can have a plurality of support devices, wherein a first support device has a first plate with a predetermined number of rail-shaped projections and a second support device has a plate with a predetermined different number of rail-shaped projections. As a result, it possible to ensure in a particularly simple manner that one pole of the electrical apparatus cannot be connected to the wrong pole of the other electrical apparatus.

A device system with an electrical apparatus according to the invention and another electrical apparatus according to the invention is particularly advantageous, wherein a connecting device of the electrical apparatus is engageable with a counter-connecting device of the other electrical apparatus in order to detachably connect the electrical apparatus to the other electrical apparatus. The electrical apparatus and the other electrical apparatus can be connected to one another electrically and/or mechanically and/or hydraulically.

The connection process for mechanically and/or electrically and/or hydraulically connecting the electrical apparatus to the other electrical apparatus has a plurality of connection steps.

To connect the electrical apparatus to the other electrical apparatus, the two apparatuses are positioned relative to each other. The positioning depends on how and where the connecting device and/or the counter-connecting device is arranged. In this way, the electrical apparatus and the other electrical apparatus can be arranged one above the other. In this case, the connection direction can be in the same direction or in the opposite direction to the force of gravity. In an alternative embodiment, the electrical apparatus and the other electrical apparatus can be arranged side by side in the horizontal direction.

As already described above, the electrical and/or mechanical and/or hydraulic connection of the electrical apparatus to the other electrical apparatus can be implemented by moving the electrical apparatus and the other electrical apparatus relative to one another. In particular, the electrical apparatus or the other electrical apparatus can be moved along the connection direction, so that the connecting device of the electrical apparatus engages with the counter-connecting device of the other electrical apparatus.

During the connection process, the connection body of the connecting device of the electrical apparatus can be inserted into the bulge of the counter-connecting device of the other electrical apparatus in the first step. As a result, in the first step, the electrical apparatus and the other electrical apparatus are aligned with one another in a first spatial direction.

The electrical apparatus and the other electrical apparatus can be aligned with one another in a second spatial direction in the second step. The alignment process in the second spatial direction can begin when the alignment process in the first spatial direction has not yet ended. Alternatively, the alignment process in the second spatial direction can only begin when the alignment process in the first spatial direction has been completed.

To align the electrical apparatus and the other electrical apparatus in the second spatial direction, the counter-alignment section of the counter-connecting device of the other electrical apparatus can penetrate into the second alignment section of the connecting device of the electrical apparatus. In addition, the rail-shaped projection of the connecting device of the electrical apparatus can penetrate into the rail-shaped recess of the counter-connecting device of the other electrical apparatus.

After aligning the electrical apparatus and the other electrical apparatus in the second spatial direction, the electrical connection of the connecting device of the electrical apparatus is aligned with the electrical counter-connection of the counter-connecting device of the other electrical apparatus. The electrical connection and the counter-connection are thus also aligned with one another in such a way that they can be electrically connected to one another.

The electrical apparatus and the other electrical apparatus can be moved relative to one another along the respective connection direction in order to implement an electrical and/or hydraulic connection between the connection and the counter-connection. The movement of the two electrical apparatuses can be guided by the rail-shaped recess in the counter-connecting device and the rail-shaped projection of the connecting device. As described above, the rail-shaped projection is engaged with the rail-shaped recess. As a result, it is ensured in a simple manner that an electrical connection cannot be established before the connecting device and the counter-connecting device are aligned relative to one another.

According to one, preferably independent, aspect of the invention, there is a connecting device and/or a counter-connecting device and/or an electrical apparatus and/or a device system. Aspects of the components are described in more detail below.

1. Connecting device for connecting an electrical apparatus to another electrical apparatus, with a connection by means of which the electrical apparatus can be electrically and/or hydraulically connected to the other electrical apparatus, a connection body which has a plurality of alignment sections which are designed in such a way that during a connection process, an alignment of the electrical apparatus to the other electrical apparatus occurs in a plurality of spatial directions in a plurality of steps.

2. Connecting device according to aspect 1, characterised in that the connection body is designed in such a way that the connection can only be electrically and/or hydraulically connected to the other electrical apparatus when the electrical apparatus (2) and the other electrical apparatus are aligned relative to one another.

3. Connecting device according to aspect 1 or 2, characterised in that the connection body is designed in such a way that
a. in a first step, the electrical apparatus can be aligned in a first spatial direction relative to the other electrical apparatus and in a second step the electrical apparatus can be aligned in a second spatial direction with respect to the other electrical apparatus and/or that
b. the connection body is designed in such a way that when the connecting device is moved along a connection direction in a first step, the electrical apparatus can be aligned in a first spatial direction with respect to the other electrical apparatus, and when the connecting device is moved further along the connection direction in a second step, the electrical apparatus can be aligned in a second spatial direction to the other electrical apparatus.

4. The connecting device according to aspect 3, characterised in that
a. the first spatial direction and the second spatial direction are perpendicular to one another and/or that
b. the first spatial direction and the second spatial direction are transverse, in particular perpendicular, to a connection direction of the connecting device.

5. Connecting device according to any one of aspects 1 to 4, characterised in that
a. the connection body has at least one first alignment section for aligning the electrical apparatus relative to the other electrical apparatus in a first spatial direction and/or that
b. the connection body has at least one second alignment section for aligning the electrical apparatus relative to the other electrical apparatus in a second spatial direction.

6. Connecting device according to aspect 5, characterised in that an edge side (8) of the connection body has the first alignment section.

7. Connecting device according to aspect 5 or 6, characterised in that
a. the first alignment section has at least one bevel or that
b. a plurality of first alignment sections are present, each having a bevel, wherein different edge sides of the connection body each have a first alignment section.

8. Connecting device according to any one of aspects 5 to 7, characterised in that
a. an edge side of the connection body has the second alignment section and/or
b. the second alignment section is arranged in the first alignment section and/or that
b. the second alignment section is formed as a longitudinal groove.

9. Connecting device according to one of aspects 5 to 8, characterised by a coupling-in section which is arranged at one end of the second alignment section.

10. Connecting device according to aspect 9, characterised in that
a. the coupling-in section is a recess and/or that
b. the coupling-in section is arranged on the first alignment section and/or that
c. the coupling-in section is longer along the second spatial direction than the second alignment section.

11. Connecting device according to one of aspects 1 to 10, characterised in that the connecting device has a connecting plate for connecting, in particular in a detachable manner, to the electrical apparatus.

12. Connecting device according to aspect 11, characterised in that the connection body protrudes from the connecting plate, in particular along the connecting direction.

13. Connecting device according to one of aspects 1 to 12, characterised by at least one rail-shaped projection which is arranged on another edge side of the connection body.

14. Connecting device according to one of aspects 1 to 13, characterised in that the connection body is hollow and that the connection is at least partially arranged within a cavity of the connection body.

15. Connecting device (1) according to one of aspects 1 to 14, characterised in that the connection has at least one power line for transmitting electrical power and/or at least one data line for transmitting data and/or a fluid line for transmitting fluid.

16. Counter-connecting device for connecting another electrical apparatus with a connecting device according to any one of aspects 1 to 15.

17. Counter-connecting device according to aspect 16, characterised in that the counter-connecting device has a counter-connection, by means of which the other electrical apparatus can be electrically and/or hydraulically connected to the connection of the connecting device.

18. Counter-connecting device according to aspect 16 or 17, characterised in that the counter-connecting device has a counter-connection body which is designed in such a way that the counter-connection can only be electrically and/or hydraulically connected to the connection when the electrical apparatus and the other electrical apparatus are aligned relative to one another.

19. Counter-connecting device according to one of aspects 16 to 18, characterised in that the counter-connecting device has a counter-connection body which is designed in such a way that
a. in a first step, the other electrical apparatus can be aligned in a first spatial direction relative to the electrical apparatus and in a second step, the other electrical apparatus can be aligned in a second spatial direction relative to the electrical apparatus and/or that
b. the counter-connection body is designed in such a way that when the counter-connecting device is moved along a connection direction in a first step, the other electrical apparatus can be aligned in a first spatial direction relative to the electrical apparatus, and when the counter-connecting device is moved further along the connection direction in a second step, the other electrical apparatus can be aligned in a second spatial direction relative to the electrical apparatus.

20. Counter-connecting device according to any one of aspects 16 to 19, characterised in that the counter-connection body has a bulge,
a. in which the connection body of the connecting device can be inserted during the connection process and/or
b. which is complementary in shape to an outer contour of the connection body of the connecting device.

21. Counter-connecting device according to one of aspects 16 to 20, characterised in that the bulge is delimited by two wall legs of the counter-connection body.

22. Counter-connecting device according to aspect 21, characterised in that the wall legs are designed and arranged in such a way that they delimit an insertion opening through which the connection body of the connecting device can be inserted into the bulge.

23. Counter-connecting device according to aspect 21 or 22, characterised in that the wall legs are designed and arranged in such a way that during a connection process, the wall legs cause the other electrical apparatus to be aligned relative to the electrical apparatus in a first spatial direction.

24. Counter-connecting device according to one of aspects 16 to 23, characterised in that the counter-connecting device has a counter-alignment section for aligning the other electrical apparatus relative to the electrical apparatus in a second spatial direction.

25. Counter-connecting device according to aspect 24, characterised in that
a. the counter-alignment section is attached to an inner side of the wall leg and/or that
b. the counter-alignment section is arranged offset to the insertion opening in the connection direction and/or that
c. the counter-alignment section is designed to be complementary in shape to the second alignment section of the connecting device.

26. Counter-connecting device according to one of aspects 16 to 25, characterised by at least one rail-shaped recess that
a. is arranged on an inner side of the counter-connection body and/or
b. is arranged in a part of the counter-connection body that is released from the bulge.

27. Counter-connecting device according to aspect 26, characterised in that the rail-shaped recess is designed to complement the rail-shaped projection of the connecting device.

28. Counter-connector according to any one of aspects 17 to 27, characterised in that the counter-connector partially extends into the bulge.

29. Counter-connecting device according to one of aspects 17 to 28, characterised in that the counter-connection has at least one power line for transmitting electrical power and/or at least one data line for transmitting data and/or at least one fluid line for transmitting fluid.

30. Electrical apparatus with at least one connecting device according to any one of aspects 1 to 15 and/or at least one counter-connecting device according to any one of aspects 16 to 29, wherein the electrical apparatus can be connected to another electrical apparatus by means of the connecting device and/or the counter-connecting device.

31. Electrical apparatus according to aspect 30, characterised in that
a. the electrical apparatus has a housing and a control device arranged in a cavity of the housing for controlling or regulating another electrical apparatus that can be connected to the electrical apparatus and/or that
b. the electrical apparatus has an electrical connection to an electrical consumer or an electrical energy source.

32. Electrical apparatus according to aspect 30 or 31, characterised in that the connecting device and/or the counter-connecting device is arranged on a housing side of the electrical apparatus.

33. Electrical apparatus according to aspect 30, characterised in that the electrical apparatus is a battery module which has a multiplicity of battery cells and a module control device for controlling or regulating the battery cells.

34. Electrical apparatus according to aspect 33, characterised in that the connecting device and the counter-connecting device are mechanically connected to one another, in particular detachably, by means of a connection housing.

35. Electrical apparatus according to aspect 34, characterised in that the connecting device is arranged on one side of the connection housing and the counter-connecting device is arranged on another side of the connection housing, wherein the connecting device and the counter-connecting device are opposite to each other.

36. Electrical apparatus according to any one of aspects 33 to 35, characterised in that the battery module has a housing which encloses the battery cells, in particular completely, wherein the connecting device and/or the counter-connecting device are arranged on a front side of the housing.

37. Electrical apparatus according to any one of aspects 30 to 36, characterised in that
a. the electrical apparatus has a plurality of connecting devices, wherein a first connecting device is arranged on a first end section of the housing and a second connecting device is arranged on a second end section of the housing and/or that
b. the electrical apparatus has a plurality of counter-connecting devices, wherein a first counter-connecting device is arranged at a first end section of the housing and a second counter-connecting device is arranged at a second end section of the housing.

38. Electrical apparatus according to any one of aspects 30 to 37, characterised in that the battery module has at least one support device for another electrical apparatus.

39. Electrical apparatus according to aspect 38, characterised in that the support device is detachably connected to the housing.

40. Electrical apparatus according to aspect 38 or 39, characterised in that the support device consists of a material which has a smaller or the same thermal expansion coefficient as the housing and/or the connecting device and/or the counter-connecting device.

41. Electrical apparatus according to any one of aspects 38 to 40, characterised in that the support device comprises a support element and a plate protruding from the support element.

42. Electrical apparatus according to aspect 41, characterised in that
a. the plate forms a wall of the connecting device and/or that
b. the plate extends in a direction away from the housing and/or that
c. a predetermined number of rail-shaped projections is arranged on the side of the plate facing away from the connecting device.

43. Electrical apparatus according to any one of aspects 30 to 42, characterised in that the electrical apparatus has at least one supporting element.

44. Electrical apparatus according to aspect 43, characterised in that the supporting element (28) is detachably connected to the housing.

45. Electrical apparatus according to aspect 43 or 44, characterised in that the supporting element consists of a material which has a smaller or the same thermal expansion coefficient as the housing and/or the connecting device and/or the counter-connecting device.

46. Electrical apparatus according to any one of aspects 39 to 45, characterised in that the electrical apparatus has a plurality of support devices, wherein a first support device has a first plate with a predetermined number of rail-shaped projections and a second support device has a plate with a predetermined different number of rail-shaped projections.

47. Apparatus system with an electrical apparatus according to any one of aspects 30 to 46 and another electrical apparatus according to any one of aspects 30 to 46, wherein in order to detachably connect the electrical apparatus to the other electrical apparatus, a connecting device of the electrical apparatus can be engaged with a counter-connecting device of the other electrical apparatus.

48. Apparatus system according to aspect 47, characterised in that the electrical and mechanical connection of the electrical apparatus to the other electrical apparatus can be implemented by means of a movement of the electrical apparatus and the other electrical apparatus relative to one another.

49. Apparatus system according to aspect 47 or 48, characterised in that during the connection process, the connection body of the connecting device of the electrical apparatus can be inserted into the bulge of the counter-connecting device of the other electrical apparatus.

50. Apparatus system according to aspect 49, characterised in that when the connection body is inserted into the bulge, the electrical apparatus and the other electrical apparatus are aligned relative to one another in a first spatial direction.

51. Device system according to aspect 50, characterised in that, in particular after aligning the electrical apparatus and the other electrical apparatus in a first spatial direction, the electrical apparatus and the other electrical apparatus are aligned relative to one another in a second spatial direction.

52. Apparatus system according to aspect 51, characterised in that for aligning the electrical apparatus and the other electrical apparatus in a second spatial direction
a. a counter alignment section of the counter connecting device of the other electrical apparatus can be inserted into the second alignment section of the connecting device of the electrical apparatus and/or that
b. a rail-shaped projection of the connecting device of the electrical apparatus can be inserted into a rail-shaped recess in the counter-connecting device of the other electrical apparatus.

53. Apparatus system according to aspect 51 or 52, characterised in that after aligning the electrical apparatus and the other electrical apparatus in a second spatial direction, the electrical connection of the connecting device of the electrical apparatus and the electrical counter-connection of the counter-connecting device of the other electrical apparatus are aligned relative to one another.

54. Apparatus system according to aspect 53, characterised in that for the electrical and/or hydraulic connection of the electrical connection to the electrical counter-connection, the electrical apparatus and the other electrical apparatus can be displaced relative to one another along the connection direction.

The subject matter of the invention is shown schematically in the figures, wherein elements that are the same or have the same effect are mostly provided with the same reference symbols. In the figures:

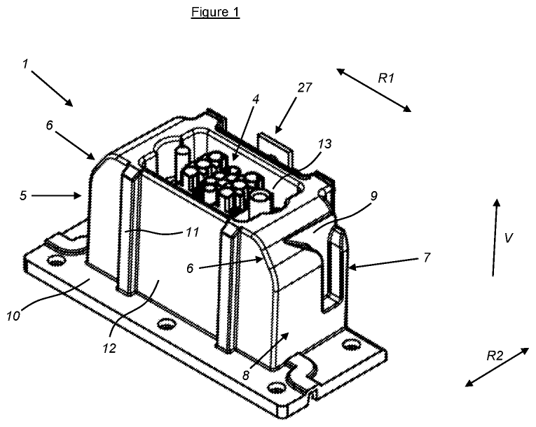

FIG. 1 shows a connecting device according to a first embodiment from one perspective,

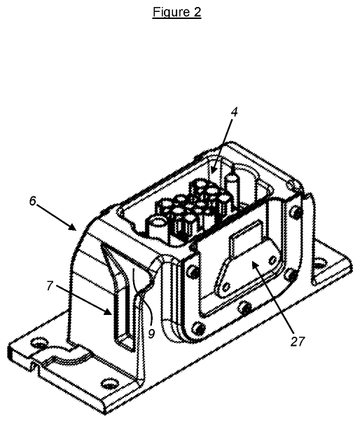

FIG. 2 shows a connecting device according to the invention according to a first embodiment from a different perspective,

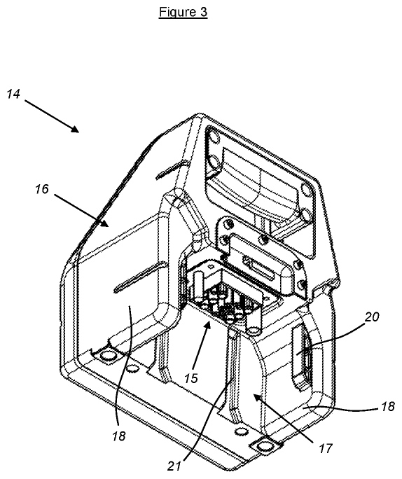

FIG. 3 shows a counter-connecting device according to a first embodiment from one perspective,

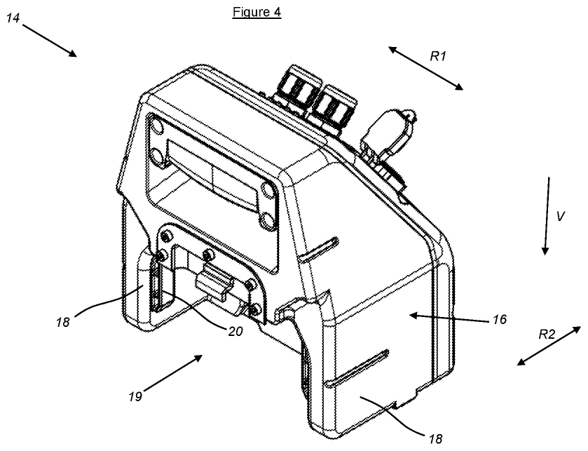

FIG. 4 shows a counter-connecting device according to a first embodiment from a different perspective,

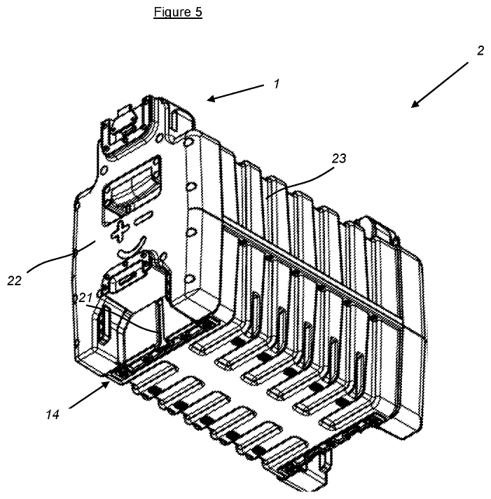

FIG. 5 shows an electrical apparatus according to the invention from one perspective,

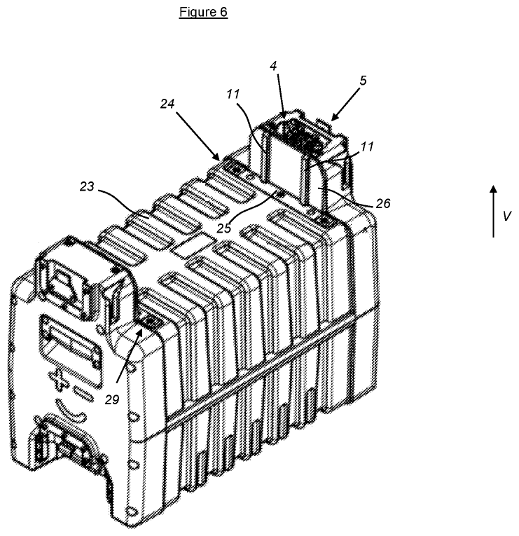

FIG. 6 shows an electrical apparatus according to the invention from a different perspective,

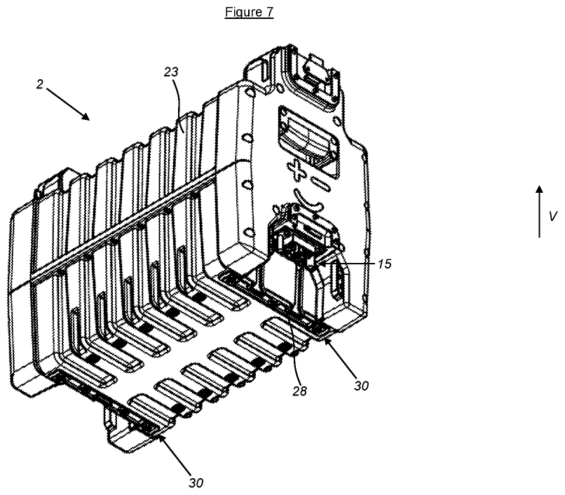

FIG. 7 shows an electrical apparatus according to the invention from a further perspective,

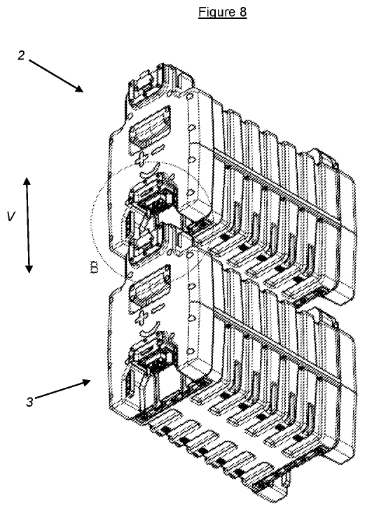

FIG. 8 shows an apparatus system according to the invention with an electrical apparatus and another electrical apparatus before a connection process,

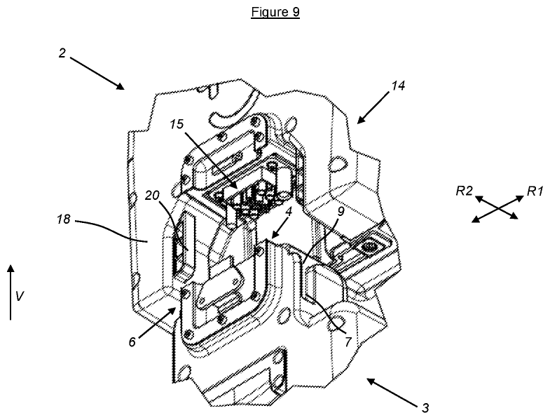

FIG. 9 shows an enlarged of a connecting area from FIG. 8,

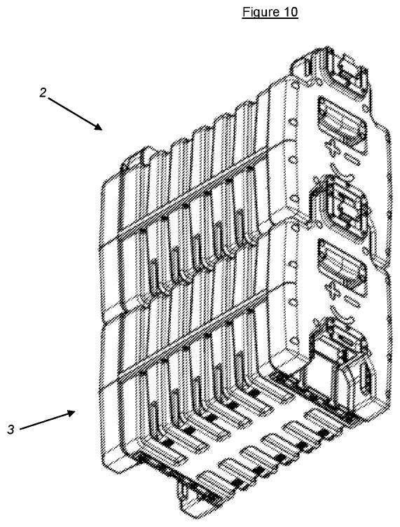

FIG. 10 shows the electrical apparatus and the other electrical apparatus in a connected state.

FIGS. 1 and 2 each show a connecting device 1 from different perspectives. By means of the connecting device 1, an electrical apparatus 2, not shown in FIG. 1, can be electrically and mechanically connected to another electrical apparatus 3, not shown in FIG. 1. The connecting device 1 has a connection 4 by means of which the electrical apparatus 2 can be electrically connected to the other electrical apparatus 3. In another embodiment, not shown, a hydraulic connection can be implemented by means of the connection 4 as an alternative or in addition to the electrical connection. In addition, the connecting device 1 has a connection body 5. The connection body 5 has a plurality of alignment sections, namely a first alignment section 6 and a second alignment section 7.

The alignment sections 6, 7 are designed in such a way that when the two electrical apparatuses 2, 3 are connected, the electrical apparatus 2 is aligned with the other electrical apparatus 3 in a plurality of spatial directions R1, R2 in a plurality of, in particular successive, steps. Since the connecting device 1 is firmly connected with the electrical apparatus 2 to the respective other electrical apparatus 3 and a counter-connecting device 3 shown in FIG. 3, during the connection process of the two electrical apparatuses 2, 3, the connecting device 2 and the counter-connecting device 3 are also aligned relative to each other, as can be seen from FIG. 9.

The connecting device 1 has a connecting plate 10, by means of which the connecting device 1 can be mechanically firmly connected to the electrical apparatus 2 in a detachable manner. The connection body 5 extends from the connection plate 10 along a connection direction V. The connection direction V corresponds to the direction along which the connecting device 1 is moved during the connection process so that the electrical apparatus 2 is electrically and mechanically connected to the other electrical apparatus 3.

The connection body 5 has a cavity 13 in which the connection 4 is arranged. The connection 4 has multiple electrical lines. The connection body 5 has a trapezoidal shape, wherein the connection body 5 tapers in cross section in a direction away from the connecting plate 10. In the case of the connecting device 1 illustrated in FIGS. 1 and 2, opposite edge sides of the connection body 5 each have a first alignment section 6 and a second alignment section 7.

The first alignment section 6 has a bevel in each case. The bevel is arranged on the end of the connection body 6 facing away from the connecting plate 10. The bevel is formed in such a way that the cross section of the connection body 5 decreases along the connecting direction V.

The same edge side 8 has a second alignment section 7. The second alignment section 7 is designed as a longitudinal groove which partially extends into the first alignment section 6. The connecting device 1 also has a coupling-in section 9 which is designed as a recess. The coupling-in section 9 is arranged on the end of the second alignment section 7 facing away from the connecting plate 10. In particular, the coupling-in section 9 is a recess in the bevel. The coupling-in section 9 has a greater width in the spatial direction R2 than the second alignment section 7.

The connecting device 1 also has two rail-shaped projections 11. The rail-shaped projections 11 run parallel to one another and extend from another edge side 12 in a direction away from the cavity 13. The rail-shaped projections 11 extend from the connecting plate 10 in the connecting direction V.

It can be seen from FIG. 2 that the edge side parallel to the other edge side 12 has a latching element 27 which interacts with a latching device not shown in the figures. The latching device has the effect that when the electrical apparatus 2 is in a connected state with the other electrical apparatus 3, one of the two devices can move unintentionally, thus preventing the connection from being released unintentionally.

FIGS. 3 and 4 show a counter-connecting device 14 from different perspectives. The counter-connecting device 14 has a counter-connection body 16 which has a bulge 17. A counter-connection 15 extends into the bulge 17.

In addition, the counter-connection body 16 has two wall legs 18 which are designed in such a way that they delimit the bulge 17. A counter-alignment section 20 is arranged on an inner side of each of the wall legs 18. The counter-alignment section 20 extends from the wall section 18 into the bulge 17. In this case, the counter-alignment section 20 is arranged in such a way that it is offset along the connection direction V with respect to an insertion opening 19. During the connection process, the connecting device 1 is inserted into the bulge 17 through the insertion opening 19. The bulge 17 is designed to be complementary in shape to an outer contour of the connecting device 1.

In addition, the counter-connecting device 14 has two rail-shaped recesses 21 in an area of the counter-connection body 16 that is released by the bulge 17. The rail-shaped recesses 21 are complementary in shape to the rail-shaped projections 11 of the connecting device 1.

FIGS. 5 to 7 show an electrical apparatus 2 from different perspectives. The electrical apparatus 2 is a battery module that has a plurality of battery cells and a module control device (not shown) for controlling the battery cells. However, the electrical apparatus 2 is not limited to being designed as a battery module.

The electrical apparatus 2 has a housing 23, the battery cells and the module control device being arranged in a cavity of the housing 23. The electrical apparatus 2 also has two connecting devices 1 according to a second embodiment and two counter-connecting devices 14 according to a second embodiment.

The connecting device 1 and the counter-connecting device 14 according to the second embodiment differ from the first embodiments shown in FIGS. 1 to 4 in that the connecting device 1 and the counter-connecting device 14 are firmly connected to each other by means of a connection housing 22. As a result, the connecting device 1, the counter-connecting device 14 and the connecting housing 22 form a structural unit. The embodiment shown in the figures has two such structural units. The electrical apparatus thus has two connecting devices 1 and two counter-connecting devices 14.

In this case, such a structural unit is arranged on one front side of the housing 23 in each case. The structural unit is detachably connected to the housing 23 in each case. The connecting device 1 and the counter-connecting device 14 are each electrically connected to the battery cells arranged inside the housing 23.

The electrical apparatus 2 also has a support device 24. The support device 24 has an elongate support element 25 which is arranged on the housing 23. In addition, the support device 24 has a plate 26 which extends from the support element 25 in the connection direction V from the housing 23. The plate 26 forms a wall of the connection body 5 of the connecting device 1. In contrast to the connecting device 1 shown in FIGS. 1 and 2, the connecting device 1 shown in FIGS. 5 to 7 has no other edge side 12.

Accordingly, the plate 26 also has the rail-shaped projections 11. As can be seen from FIG. 6, the plate 26 has two rail-shaped projections 11. The electrical apparatus 2 also has a further support device 29. The further support device 29 differs from the support device 24 in the design of the plate. The plate of the further support device 29 has only one rail-shaped projection 11, which is not shown in the figures.

In this case, an end of the connection 4 that is not shown in FIG. 6 is electrically connected to the battery cells arranged in the housing 23. The other end of the connection 4 can be electrically connected to the counter-connection 15 of the counter-connecting device 14. Likewise, an end of the counter-connection 15 not shown in FIG. 7 is electrically connected to the battery cells arranged in the housing 23. The other end of the counter-connection 15 can be connected to the electrical connection 4.

As can be seen from FIG. 7, the electrical apparatus 2 also has a support section 30 at both ends. The supporting section 30 has a supporting element 28, which is arranged on the housing 23. The support device 24 and the support section 29 are arranged on opposite sides of the housing 23 with respect to the connection direction V.

When the electrical apparatus 2 is mechanically and electrically connected to another electrical apparatus 3 that is identical to electrical apparatus 2, the supporting element 28 of electrical apparatus 2 rests directly on the support element 25 of the other electrical apparatus 3.

FIG. 8 shows an apparatus system according to the invention with an electrical apparatus 2 and another electrical apparatus 3 before a connection process. As can be seen from FIG. 8, the electrical apparatus 2 and the other electrical apparatus 3 are identical to one another. The electrical apparatus 2 is positioned above the other electrical apparatus 3. For the mechanical and electrical connection of the two electrical apparatuses, the electrical apparatus 2 and/or the other electrical apparatus 3 are moved along the respective connection direction V. The connection direction V of the electrical apparatus 2 is aligned in the opposite direction to the connection direction V of the other electrical apparatus 3.

FIG. 9 shows an enlarged view of a connection area of FIG. 8, which is circled in FIG. 8. In particular, part of the counter-connecting device 14 of the electrical apparatus 2 and part of the connecting device 1 of the other electrical apparatus 3 are shown. For mechanical and electrical connection, it is assumed below that the other electrical apparatus 3 is moved along the connection direction V.

When the other electrical apparatus 3 moves, in a first step of the connection process, the first alignment section 6, in particular the bevel, comes into contact with the wall leg 18 of the counter-connecting device 14. When the other electrical apparatus 3 moves further, the other electrical apparatus 3 is aligned relative to the electrical apparatus 2 along the first spatial direction R1.

Then, in a second step of the connection process, the other electrical apparatus 3 is moved further along the connection direction V, so that the counter-alignment section 20 of the counter-connecting device 14 penetrates into the coupling-in section 9 of the connecting device 1. The other electrical apparatus 3 is moved further in the connection direction V, so that the counter-alignment section 20 penetrates into the second alignment section 7, in particular the longitudinal groove. As a result, the other electrical apparatus 3 is aligned relative to the first electrical apparatus 2 in the second spatial direction R2.

The electrical apparatus 2 and the other electrical apparatus 3 are now arranged in such a way that the connection 4 of the connecting device 1 can be electrically connected to the counter-connection 15 of the counter-connecting device 14. For this purpose, the other electrical apparatus 3 is moved further along the connection direction V, with the rail-shaped recess 21 in which the rail-shaped projection 11 engages guiding the movement of the other electrical apparatus 3.

After the electrical connection 4 has been electrically connected to the counter-connection 15, the electrical apparatus 2 is mechanically and electrically connected to the other electrical apparatus 3. FIG. 10 shows an illustration of the electrical apparatus 2 and the other electrical apparatus 3 in a connected state.

### List of Reference Numerals

1 Connecting device

2 First electrical apparatus

3 Second electrical apparatus

4 Electrical connection

5 Connection body

6 First alignment section

7 Second alignment section

8 Edge side

9 Coupling-in section

10 Connecting plate

11 Rail-shaped projection

12 Other edge side

13 Cavity

14 Counter-connecting device

15 Electrical counter-connection

16 Counter-connection body

17 Bulge

18 Wall legs

19 Insertion opening

20 Counter-alignment section

21 Rail-shaped recess

22 Connection housing

23 Housing

24 Support device

25 Support element

26 Plate

27 Latching element

28 Supporting element

29 Further support device

30 Supporting section

V Connection direction

R1 First spatial direction

R2 Second spatial direction

1.-50. (canceled)

51. A battery module comprising:
a plurality of battery cells;
a module control device for controlling or regulating the battery cells; and
at least one connecting device for connecting the battery module to another battery module, including a connection by means of which the battery module can be electrically and/or hydraulically connected to the other battery module, a connection body which has a plurality of alignment sections which are designed in such a way that during a connection process, the battery module is aligned relative to the other battery module in a plurality of spatial directions in a plurality of steps, wherein
the connection body is designed in such a way that when the connecting device is moved in a connecting direction in a first step, the battery module can be aligned in a first spatial direction relative to the other battery module and when the connecting device is moved further along the connecting direction in a second step, the battery module can be aligned in a second spatial direction relative to the other battery module and that the connection can only then be electrically and/or hydraulically connected to the other battery module when the battery module and the other battery module are aligned with one another.

52. The battery module according to claim 51, wherein:
a. the first spatial direction and the second spatial direction are perpendicular to one another; and
b. the first spatial direction and the second spatial direction are perpendicular, to a connection direction of the connecting device.

53. The battery module according to claim 51, wherein:
a. the connection body has at least one first alignment section for aligning the battery module relative to the other battery module in a first spatial direction; and
b. the connection body has at least one second alignment section for aligning the battery module relative to the other battery module in a second spatial direction.

54. The battery module according to claim 51, wherein the connecting device has a connecting plate for connection in a detachable manner to the battery module.

55. The battery module according to claim 51, wherein at least one rail-shaped projection is arranged on another edge side of the connection body.

56. The battery module according to claim 51, wherein the connection body is hollow and the connection is at least partially arranged within a cavity of the connection body.

57. The battery module according to claim 51, wherein the connection has at least one energy line for transmitting electrical energy and/or at least one data line for transmitting data and/or a fluid line for transmitting fluid.

58. The battery module according to claim 51, wherein the battery module has at least one counter-connecting device for connecting the battery module to another battery module.

59. The battery module according to claim 58, wherein the counter-connecting device has a counter-connection, by means of which the battery module is connected electrically and/or is hydraulically connectable to the connection of a connecting device of another battery module.

60. The battery module according to claim 59, wherein the counter-connecting device has a counter-connection body which is designed in such a way that the counter-connection can only be electrically and/or hydraulically connected to the connection when the battery module and the other battery module are aligned relative to one another.

61. The battery module according to claim 58, wherein the counter-connecting device has a counter-connection body, which is designed in such a way that:
a. in a first step, the other battery module can be aligned in a first spatial direction relative to the battery module and in a second step, the other battery module can be aligned in a second spatial direction relative to the battery module; and
b. the counter-connection body is designed in such a way that when the counter-connecting device is moved along a connection direction in a first step, the other battery module can be aligned in a first spatial direction relative to the battery module and when the counter-connecting device moves further along the connection direction in a second step, the other battery module can be aligned in a second spatial direction relative to the battery module.

62. The battery module according to claim 61, wherein the counter-connection body has a bulge:
a. into which the connection body of the connecting device can be inserted during the connection process; and
b. that is complementary in shape to an outer contour of the connection body of the connecting device.

63. The battery module according to claim 58, characterised in that the counter-connecting device has a counter-alignment section for aligning the other battery module relative to the battery module in a second spatial direction.

64. The battery module according to claim 61, including at least one rail-shaped recess arranged on an inner side of the counter-connection body, wherein the rail-shaped recess is designed to complement the rail-shaped projection of the connecting device.

65. The battery module according to claim 59, wherein the counter-connection has at least one power line for transmitting electrical power and/or at least one data line for transmitting data and/or at least one fluid line for transmitting fluid.

66. The battery module according to claim 58, wherein the connecting device and the counter-connecting device are mechanically connected to one another in a detachable manner by means of a connection housing.

67. The battery module according to claim 51, wherein the battery module has a housing which encloses the battery cells, and wherein the connecting device is arranged on a front side of the housing.

68. The battery module according to claim 67, wherein:
a. the battery module has a plurality of connecting devices, wherein a first connecting device is arranged on a first end section of the housing and a second connecting device is arranged on a second end section of the housing; and
b. the battery module has a plurality of counter-connecting devices, wherein a first counter-connecting device is arranged on a first end section of the housing and a second counter-connecting device is arranged on a second end section of the housing.

69. The battery module according to claim 67, wherein the battery module has at least one support device for another battery module, the support device being detachably connected to the housing.

70. The battery module according to claim 69, wherein the battery module has a plurality of support devices, wherein a first support device has a first plate with a predetermined number of rail-shaped projections and a second support device has a plate with a predetermined different number of rail-shaped projections.
